(19) United States
(12) Patent Application Publication
(10) Pub. No.: US 2008/0052354 A1
(43) Pub. Date: Feb. 28, 2008

(54) METHOD OF GIVING THE INVITEE INFORMATION ON AN INSTANT MESSAGING MEETING PRIOR TO ACCEPTANCE

(75) Inventors: Cynthia E. Barber-Mingo, Westford, MA (US); Cora Clerkin, Drogheda (IE); Gary Denner, Celbridge (IE); Patrick J. O'Sullivan, Ballsbridge (IE); Sonya Purcell, Cashel (IE)

Correspondence Address: CANTOR COLBURN LLP - IBM LOTUS, 20 Church Street, 22nd Floor, Hartford, CT, 06103, US

(73) Assignee: International Business Machines Corporation, Armonk, NY (US)

(21) Appl. No.: 11/466,146

(22) Filed: Aug. 22, 2006

(51) Int. Cl. G06F 15/16

(52) U.S. Cl. 709/204

(57) ABSTRACT

A method for distributing information to an invitee of an instant messaging (IM) meeting prior to acceptance of the meeting. The method includes initiating an instant message (IM) meeting via a moderator. The next step includes sending an invitation to an invitee to join the meeting. The invitation includes the following forms of information chosen to be displayed by the moderator, (i) the participants' names, (ii) the length of time of the chat, (iii) the chat history, and (iiii) whether the meeting is in lock-down mode. The method concludes with displaying a menu having check boxes to the invitee. The check boxes allow the invitee to request additional information about the IM meeting.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to computer systems for providing instant messaging and, more particularly, to a method for distributing information to an invitee of an instant messaging (IM) meeting.

2. Description of Background

Instant messaging is a convenient mode of communication, but has drawbacks. The following example illustrates deficiencies in current instant messaging processes. Sean is a busy sales rep that uses instant messaging (IM) continuously and constantly to communicate with colleagues and customers all around the world. He gets pinged throughout the day on issues from up and coming new software, support queries and end of quarter calculations. He answers as much as he can but sometimes ends up declining IM chat invites because he doesn't know who is involved and how long the chat might take and what has already been said. Last quarter end he declined a chat as it was close to his deadline and wanted to make as many sales as he could. This chat proved to have been very useful to his colleagues who were informed of a late discount on some stock and managed to move a large amount of this to improve their numbers. The information gap that exists in the IM meetings/chats mean that unless more information is provided certain people decline meetings due to time constraints, other meetings or general work demands.

Instant message meetings are a great way of communication with other colleagues around the world. The invite appears on your desktop with the subject to be discussed and your choice is to either accept or decline it. However, this leaves the invitee wondering whether to accept or not. There is an information gap about this chat/meeting.

Thus, there is a need to minimize and essentially eliminate the information gap about the chat/meeting.

### SUMMARY OF THE INVENTION

The shortcomings of the prior art are overcome and additional advantages are provided through the provision of a method for distributing information to an invitee of an instant messaging (IM) meeting prior to acceptance of the meeting. The method includes initiating an instant message (IM) meeting via a moderator. The next step of the method includes sending an invitation to an invitee to join the meeting. The invitation includes the following forms of information chosen to be displayed by the moderator, (i) the participants' names, (ii) the length of time of the chat, (iii) the chat history, and (iiii) whether the meeting is in lock-down mode. The next step of the method includes displaying a memo having check boxes to the invitee. The check boxes allow the invitee to request additional information about the IM meeting.

Additional features and advantages are realized through the techniques of the present invention. Other embodiments and aspects of the invention are described in detail herein and are considered a part of the claimed invention. For a better understanding of the invention with advantages and features, refer to the description and to the drawing.

### TECHNICAL EFFECTS

As a result of the summarized invention, technically we have achieved a solution for a method for distributing information to an invitee of an instant messaging (IM) meeting prior to acceptance of the meeting.

### BRIEF DESCRIPTION OF THE DRAWINGS

The subject regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a method for distributing information to an invitee of an instant messaging meeting in accordance with an embodiment of the disclosed invention;

FIG. 2A illustrates one example of a screen diagram showing an illustrative screen display including an instant message chat window in accordance with an embodiment of the disclosed invention; and

FIG. 2B illustrates one example of another screen diagram showing another illustrative screen display including an instant message chat window in accordance with an embodiment of the disclosed invention.

The detailed description explains an exemplary embodiment of the invention, together with advantages and features, by way of example with reference to the drawing.

### DETAILED DESCRIPTION OF THE INVENTION

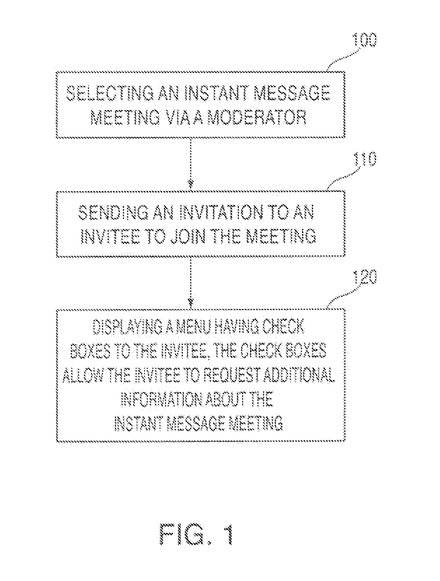

Referring to FIG. 1, a method for distributing information to an invitee of an instant messaging (IM) meeting prior to acceptance of the meeting, is shown.

Starting at step 100, an instant message meeting is initiated by a moderator. Subsequently, at step 110, an invitation is sent to an invitee to join the meeting. The invitation includes at least one of the following forms of information chosen to be displayed by the moderator; (i) the participants' names, (ii) the length of time of the chat, (iii) the chat history, and (iiii) whether the meeting is in lock-down mode. Then at step 120, a menu having check boxes is displayed to the invitee. The check boxes allow the invitee to request additional information about the IM meeting.

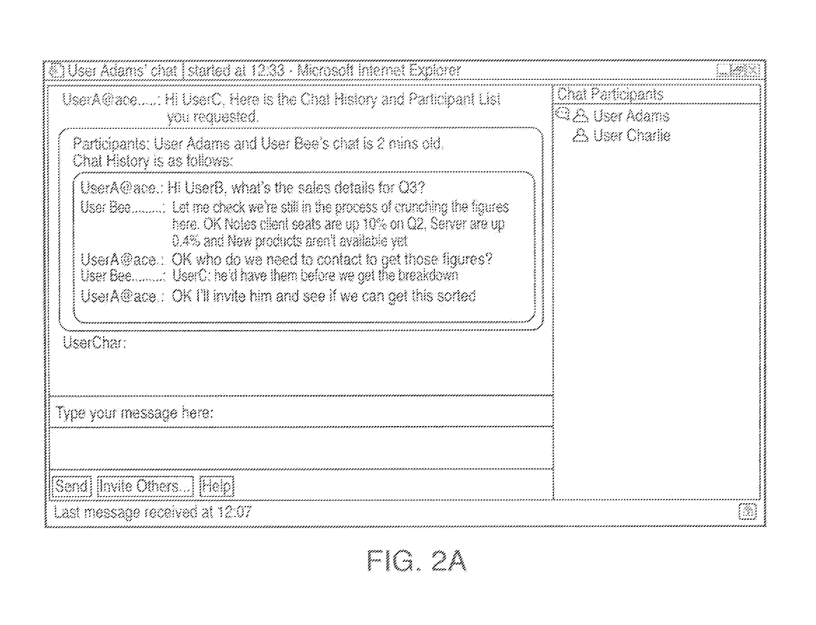

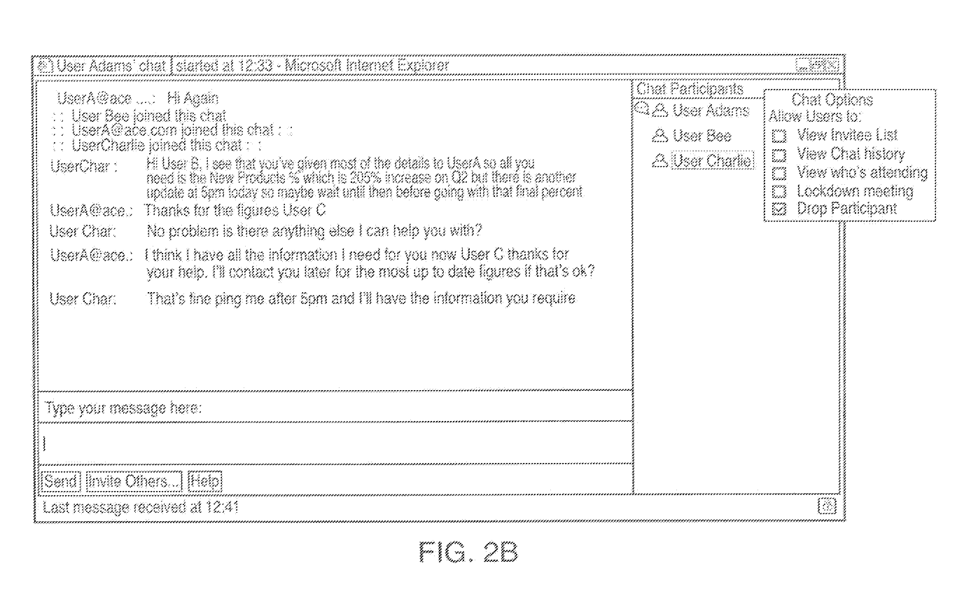

The moderator views the menu with the check boxes prior to the invitees viewing the menu when the IM is initiated. The moderator selects particular check boxes that correspond to particular information that the moderator wants displayed to the participants of the IM, as shown in FIG. 2A.

When the moderator does not by default display: (i) the participants' name, (ii) the length of time of the chat, (iii) the chat history, and (iiii) whether the meeting is in lock-down mode, the invitee may select via a check box on the menu the option of including anyone or all of this information, as shown in FIG. 2B.

The chat history is identifiable by at least one of the following: (i) being represented by icons, and (ii) being color coded, to allow the invitee to distinctly keep track of the flow of conversation during the meeting. Furthermore, the chat history forwarded to the invitees from the moderator may be a selected subset of the total history that the moderator finds relevant.

The invitee may also optionally select via a check box on the menu the option of including information regarding who accepted and declined the invitation. Additionally, the invitee may select via a checkbox on the menu the option of including information regarding the time limit scheduled for the meeting. The invitee may also select via a check box on the menu the option of including information regarding what participants of the meeting are on-line and how long the participants have been on-line chatting. Furthermore, the invitee may also select via a check box on the menu the option of including information regarding what invitees have previously departed the meeting and what invitees have not joined the meeting.

The moderator is granted permission to open the meeting to others provided all the invitees agree to such an action. The moderator is also granted permission to display and as well as not to display the chat history. Additionally, the moderator is granted permission to lock the meeting such that only current participants may join the meeting until the lock condition is removed by the moderator. Furthermore, the moderator may release the invitee from the IM meeting one the invitee's information to the IM meeting has been imparted. This functionality gives the moderator security by knowing what invitees are involved in the IM meeting at any particular time.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for distributing information to an invitee of an instant messaging (IM) meeting prior to acceptance of the meeting, comprising:
initiating an instant message(IM) meeting via a moderator;
sending an invitation to an invitee to join the meeting, the invitation including the following forms of information chosen to be displayed by the moderator, (i) the participants' names, (ii) the length of time of the chat, (iii) the chat history, and (iiii) whether the meeting is in lock-down mode; and
displaying a menu having check boxes to the invitee, the check boxes allow the invitee to request additional information about the IM meeting.

2. The method of claim 1, wherein the invitee may select via a check box on the menu the option of including information regarding, (i) the participants' name, (ii) the length of time of the chat, (iii) the chat history, and (iiii) whether the meeting is in lock-down mode, for display when the moderator does not by default display such information.

3. The method of claim 2, wherein the chat history is at least one of, (i) represented by icons, and (ii) color coded, to allow the invitee to distinctly keep track of the flow of conversation during the meeting.

4. The method of claim 3, wherein the chat history forwarded to the invitees may be a selected subset of the total history that the moderator finds relevant.

5. The method of claim 4, wherein the invitee may select via a check box on the menu the option of including information regarding who accepted and declined the invitation.

6. The method of claim 5, wherein the invitee may select via a check box on the menu the option of including information regarding the time limit scheduled for the meeting.

7. The method of claim 6, wherein the invitee may select via a check box on the menu the option of including information regarding what participants of the meeting are on-line and how long the participants have been on-line chatting.

8. The method of claim 7, wherein the invitee may select via a check box on the menu the option of including information regarding what invitees have previously departed the meeting and what invitees have not joined.

9. The method of claim 8, wherein the moderator is granted permission to open the meeting to others provided all the invitees agree to such an action.

10. The method of claim 9, wherein the moderator is granted permission to display and not display the chat history.

11. The method of claim 10, wherein the moderator views the menu with the check boxes prior to the invitees viewing the menu when the IM is initiated, the moderator selects particular check boxes that correspond to particular information that the moderator wants displayed to the participants of the IM meeting.

12. The method of claim 11, wherein the moderator is granted permission to lock the meeting such that only current participants may engage in the meeting until the lock condition is removed by the moderator.

13. The method of claim 12, wherein the moderator may release the invitee from the IM meeting once the invitee's information to the IM meeting has been imparted.
